(19) United States
(12) Patent Application Publication
(10) Pub. No.: US 2026/0171474 A1
(43) Pub. Date: Jun. 18, 2026

(54) Method for Manufacturing a Cylindrical Battery Cell for a Traction Battery of a Motor Vehicle, and Cylindrical Battery Cell

(71) Applicant: Bayerische Motoren Werke Aktiengesellschaft, Muenchen (DE)

(72) Inventors: Niclas EMRICH, Muenchen (DE); Daniel PRITZL, Zachenberg (DE)

(21) Appl. No.: 19/126,701

(22) PCT Filed: Oct. 18, 2023
(86) PCT No.: PCT/EP2023/079005

§ 371 Date: May 2, 2025

(30) Foreign Application Priority Data
Nov. 24, 2022 (DE) 10 2022 131 095.7

(51) Int. Cl. H01M 10/0525; H01M 10/42

(52) U.S. Cl. CPC H01M 10/0525; H01M 10/425

(57) ABSTRACT

A method for manufacturing a cylindrical battery cell for a traction battery of a motor vehicle, in which method: an electrode coil is wound, a cathode contact region being arranged on the first end face of said electrode coil and an anode contact region being arranged on the second end face of said electrode coil opposite the first end face; the cathode contact region and the anode contact region are flattened at the end faces; a cathodic current collector plate is welded to the flattened cathode contact region; a housing cover is welded directly to the flattened anode contact region; the electrode coil is inserted into a housing cylinder; the cathodic current collector plate is electrically connected to a positive pole of the housing cylinder; and the housing cover is connected to the housing cylinder.

### BACKGROUND AND SUMMARY

The invention relates to a method for manufacturing a cylindrical battery cell for a traction battery of a motor vehicle, and to a cylindrical battery cell for a traction battery of a motor vehicle.

U.S. Pat. No. 9,805,877 B2 discloses an energy storage device having an electrode coil and current collectors which are arranged on the respective end faces of the electrode coil.

A battery cell having an electrode coil is also known from EP 2 476 156B1. The electrode coil is positioned in a container. Respective collector disks are arranged at opposing ends of the electrode coil. The negative and positive collector disks function as internal terminals, wherein the negative collector disk is electrically connected to the negative electrode and the positive collector disk is electrically connected to the positive electrode. The housing can comprise a cover and a receptacle. The cover and the receptacle function as external terminals. The negative collector disk comprises a tab for connecting the negative collector disk to the cover. The positive collector disk is welded to the receptacle, or is otherwise electrically bonded thereto.

The object of the present invention is the provision of a solution which enables a manufacture of particularly compact battery cells, which battery cells can be charged in a particularly rapid manner.

According to the invention, this object is fulfilled by the subject matter of the independent claims. Further potential configurations of the invention are disclosed in the sub-claims, in the description and in the figures. Features, advantages and potential configurations which are presented in the context of the description of an element of the subject matter of the independent claims are at least to be considered as analogous to features, advantages and potential configurations of the respective subject matter of the other independent claims, and of each potential combination of the subject matter of the independent claims, optionally in association with one or more of the sub-claims.

The invention relates to a method for manufacturing a cylindrical battery cell for a traction battery of a motor vehicle. In particular, this traction battery of the motor vehicle comprises a plurality of cylindrical battery cells which, for example, can be “lithium-ion” battery cells. The cylindrical battery cell is a round cell. By means of electrical energy supplied from the traction battery, the motor vehicle can be electrically propelled. Thus, in particular, the motor vehicle is an electric vehicle or a hybrid vehicle.

According to the method, it is provided that a multi-layer foil, which at least comprises a cathode which is embodied in the form of a foil, having a foil-like cathode contact region which is electrically contiguous thereto, and at least one anode which is embodied in the form of a foil, having a foil-like anode contact region which is electrically contiguous thereto, is wound to form an electrode coil. This means that the cathode which is embodied in the form of a foil and the anode which is embodied in the form of a foil and which, in the multi-layer foil, are electrically isolated from one another by means of at least one separator, are commonly wound about a coil axis, as a result of which the electrode coil is produced. This coil axis coincides with a longitudinal direction of the electrode coil. The cathode contact region is arranged at the first end face of the electrode coil, and the anode contact region is arranged at the second end face of the electrode coil, which second end face is arranged opposite the first end face. By means of the anode contact region, the anode can be electrically contact-connected and, by means of the cathode contact region, the cathode can be electrically contact-connected. By the arrangement of the anode contact region and of the cathode contact region at respectively opposing end faces of the electrode coil, any risk of direct electrical contact between the cathode and the anode, and a consequent risk of a short-circuit, can be restricted to a particularly low level.

According to the method, it is further provided that the cathode contact region and the anode contact region are flattened at the respective end faces. For the purposes of flattening, the respective contact region is bent over, as a result of which a cathode contact surface or an anode contact surface is formed at the respective end faces. By the reshaping of the cathode contact region or of the anode contact region, the respective contact region which, on the grounds of the coil structure, projects beyond the respective end face of the electrode coil, is flattened in the axial direction, as a result of which a longitudinal direction of extension of the electrode is shortened. Moreover, an orientation of the respective contact regions is altered by flattening, if the respective contact regions are press-fitted to the end faces. The contact surfaces produced by the flattening of the contact regions can be contact-connected to a respective positive pole or to a respective negative pole of the battery cell in a particularly simple manner, as a result of which a particularly effective inflow of current to the battery cell and an outflow of current from the battery cell are enabled.

According to the method, it is further provided that a cathodic current collector plate is welded to the flattened cathode contact region. This cathodic current collector plate is a collector plate which is designed to collect current, and to relay the collected current. By means of the cathodic current collector plate, the cathode can be electrically contact-connected in a particularly effective manner, via the flattened cathode contact regions. According to the method, it can further be provided that a housing cover is welded directly to the flattened anode contact region. This means that no anodic current collector plate is provided whereas, instead, the housing cover engages directly with the flattened anode contact region and is welded thereto, and is thus bonded in an electrically conductive manner. As no anodic current collector plate is provided in the cylindrical battery cell, the anode contact region assumes a particularly low contact resistance, as a result of which a particularly rapid charging and discharging of the cylindrical battery cell are enabled. Moreover, the cylindrical battery cell, as a result of the direct contact between the flattened anode contact region and the housing cover, assumes a particularly low height, and is thus of a particularly compact design. A given structural space can thus be utilized in a particularly effective manner and, as a result of the particularly compact design, can be fully occupied by a particularly high number of battery cells. In consequence, a given structural space can be employed for the provision of a particularly large storage capacity.

According to the method, it is further provided that the electrode coil is inserted in a housing cylinder, and that the cathodic current collector plate is electrically bonded to a positive pole of the housing cylinder. This means that the electrode coil, at a first end face on which the cathodic current collector plate is arranged, is previously inserted in the housing cylinder, as a result of which the cathodic current collector plate, on the inner side of the housing cylinder, is electrically contact-connected with the positive pole. In particular, the positive pole is positioned at a side of the housing cylinder which is arranged opposite an opening in the housing cylinder. In the inserted state of the electrode coil in the housing cylinder, the anode contact region is thus oriented towards the end of the housing cylinder which incorporates the opening. Through the unclosed opening of the housing cylinder, the anode contact region, or the housing cover which is welded directly to the anode contact region, is thus visible. According to the method, it is provided that, finally, the housing cover is bonded to the housing cylinder. As a result, an electrical contact-connection of the anode contact region with the negative pole of the cylindrical battery cell is thus achieved. In the context of the method, the cylindrical battery cell of a particularly compact design can thus be manufactured in a particularly simple manner.

According to a potential further development of the invention, it is provided that the cathode contact region extends as a continuous region along a first side of the multi-layer foil, and that the anode contact region extends as a continuous region along a second side of the multi-layer foil, which is arranged opposite the first side. Upon the flattening of the respective continuous regions, these regions are reshaped towards a central axis of the electrode coil. This means that the respective contact regions, at the end faces of the electrode coil, are bent over radially from the exterior towards the interior. As a result, sections of the respective contact regions, which are arranged in different winding layers of the electrode coil, engage in mutual contact, and are thus mutually electrically contact-connected. At the respective end faces of the electrode winding, a large contact surface is thus provided. This large contact surface can be welded to the cathodic current conductor plate, or can be directly welded to the housing cover, in a particularly effective manner. As the respective continuous contact regions extend on respectively opposing sides of the multi-layer foil, the respective areas of the contact regions, upon the flattening thereof at the respective end faces, mutually interlock in a particularly effective manner. In consequence, in the respectively flattened state, the contact regions are maintained in the shape of the contact plate in a particularly effective manner. Any reversal of the reshaping of the contact regions can thus be prevented in a particularly effective manner.

According to a further potential configuration of the invention, it is provided that the cathode contact region and the anode contact region are respectively subdivided into a multiplicity of pennant-shaped segments which, upon flattening, are partially mutually overlaid. For the provision of the multiplicity of pennant-shaped segments of the anode contact region or of the cathode contact region, the respective sides of the multi-layer foil on which the respective contact region is arranged can be repeatedly incised, in particular by means of at least essentially parallel cuts, as a result of which pennant-shaped segments are formed on the respective sides of the multi-layer foil. By the configuration of the respective contact regions with pennant-shaped segments, for the purposes of flattening, the pennant-shaped segments can be sequentially bent over in a radial direction towards the central axis of the electrode coil. In consequence, the pennant-shaped segments are thus at least partially overlaid in a petal-like pattern, as a result of which the pennant-shaped segments can engage with the respective end faces in a particularly flat arrangement. In consequence, the electrode coil can be provided with a particularly low height in the longitudinal direction of extension. In the context of the method, a particularly compact battery cell is produced as a result.

According to a further potential configuration of the invention, it is provided that the housing cover is welded to the housing cylinder. In particular, a helium-tight welding of the housing cover to the housing cylinder is executed. By means of welding, the housing cover is attached to the housing cylinder in a particularly secure manner and, moreover, a particularly effective electrical contact is provided between the housing cover and the housing cylinder. Moreover, the housing formed by the housing cover and the housing cylinder, as a result of the welding of the housing cover to the housing cylinder, is embodied in a particularly stable manner.

According to a further potential configuration of the invention, it is provided that the cathodic current collector plate is welded to the positive pole. By the welding of the cathodic current collector plate to the positive pole, the cathodic current collector plate is bonded to the positive pole in a particularly secure manner. Any risk of the detachment of the cathodic current collector plate, and thus of the loss of electrical contact between the cathodic current collector plate and the positive pole, can thus be restricted in a particularly effective manner.

According to a further potential configuration of the invention, it is provided that a core is axially inserted in the center of the electrode coil. This core can comprise a through-opening which is oriented in the axial direction, which through-opening is designed to conduct any gas which is generated in the event of a thermal runaway of the battery cell to the respective end faces of the battery cell. As a result, gas which is generated in the event of a thermal runaway of the battery cell can be evacuated from the battery cell in a particularly rapid manner. The core can moreover be designed to stabilize the shape of the electrode coil. Particularly in the event of any strain in the cathode or anode, and thus in the electrodes of the electrode coil over the service life of the battery cell, deformation of the electrodes can be restricted, and thus limited, by means of the core. The core can be designed to at least partially circumferentially enclose a channel which extends in an axial direction through the electrode coil, and is thus maintained clear of the multi-layer foil, by means of which any gas generated in the event of a thermal runaway of the battery cell can be routed via the channel, in a particularly secure manner, to the respective ends of the battery cell. The core can also be described as a “mandrel”.

According to a further potential configuration of the invention, it is provided that the housing cover is welded to the flattened anode contact region by means of at least one curved and undulating welded seam. As a result of the undulating configuration of the welded seam, a particularly high number of different regions of the respective contact regions in different winding layers of the electrode coil can be welded to the housing cover by means of the welded seam, and can thus be securely bonded to the housing cover. Accordingly, a particularly secure mechanical and electronic contact between the anode contact region and the housing cover is established. Any risk of the detachment of the housing cover from the anode contact region can thus be restricted in a particularly effective manner.

According to a potential further development of the invention, it is provided that a sinusoidal waveform of the welded seam is preferred. By means of the sinusoidal configuration of the welded seam, abrupt changes of direction of the welded seam can be prevented. In consequence, a welding apparatus employed for the formation of the welded seam can be operated continuously, in particular at a consistent speed. In consequence, the welded seam comprises a particularly low number of weak spots, and enables a particularly secure bonding of the housing cover to the anode contact region.

According to a further potential configuration of the invention, it is provided that the housing cover is welded to the flattened anode contact by means of multiple curved and undulating welded seams, wherein the multiple curved and undulating welded seams are distributed over the perimeter of the housing cover in a mutually uniformly spaced arrangement. For example, the multiple undulating welded seams can form a circle along the perimeter of the end face of the electrode coil, in an undulating outline, which circle comprises multiple interruptions, according to the number of welded seams. It is thus enabled, firstly, that the housing cover is secured to the anode contact region in a particularly effective manner over its entire perimeter, and that, moreover, a mechanical loading of the individual welded seams is restricted to a particularly low level. This low mechanical loading results from the interruptions of the welded seam over the perimeter of the end face, which interruptions enable a strain in the electrodes of the electrode coil over the service life of the battery cell to be accommodated.

The invention moreover relates to a cylindrical battery cell for a traction battery of a motor vehicle. In particular, the traction battery comprises a multiplicity of cylindrical battery cells. In particular, the cylindrical battery cell has been manufactured in the context of a method of type described above in conjunction with the method according to the invention for manufacturing a cylindrical battery cell. The cylindrical battery cell comprises an electrode coil, which is wound from a multi-layer foil. The multi-layer foil comprises at least one cathode which is embodied in the form of a foil, having a foil-like cathode contact region which is electrically contiguous thereto, and an anode which is respectively embodied in the form of a foil, having a foil-like anode contact region which is electrically contiguous thereto. The cathode contact region is arranged and flattened at the first end face of the electrode coil. The anode contact region is arranged and flattened at the second end face of the electrode coil, which is arranged opposite the first side. The cylindrical battery cell moreover comprises a cathodic current collector plate, which is welded to the flattened cathode contact region. The cylindrical battery cell moreover comprises a housing cover, which is welded directly to the flattened anode contact region. The cylindrical battery cell additionally comprises a housing cylinder, in which the electrode coil is inserted, to the positive pole of which the cathodic current collector plate is electrically bonded, in particular by welding, and to which the housing cover is welded. The housing cover is welded to the housing cylinder, at a side of the housing cylinder which is arranged opposite the positive pole.

Further features of the invention can be inferred from the claims, the figures and the description of the figures. Features and combinations of features specified in the preceding description, and features and combinations of features which are illustrated hereinafter in the description of the figures and/or in the figures alone are not only applicable in the respectively indicated combination, but also in other combinations or in isolation, without departing from the scope of the invention.

### BRIEF DESCRIPTION OF THE DRAWINGS

FIG. 1 shows a process diagram of a method for manufacturing a cylindrical battery cell, in respective perspective views; and

FIG. 2 shows a process diagram of a method for manufacturing a cylindrical battery cell, in respective sectional views.

In the figures, identical and functionally equivalent elements are identified by the same reference symbols.

### DETAILED DESCRIPTION OF THE DRAWINGS

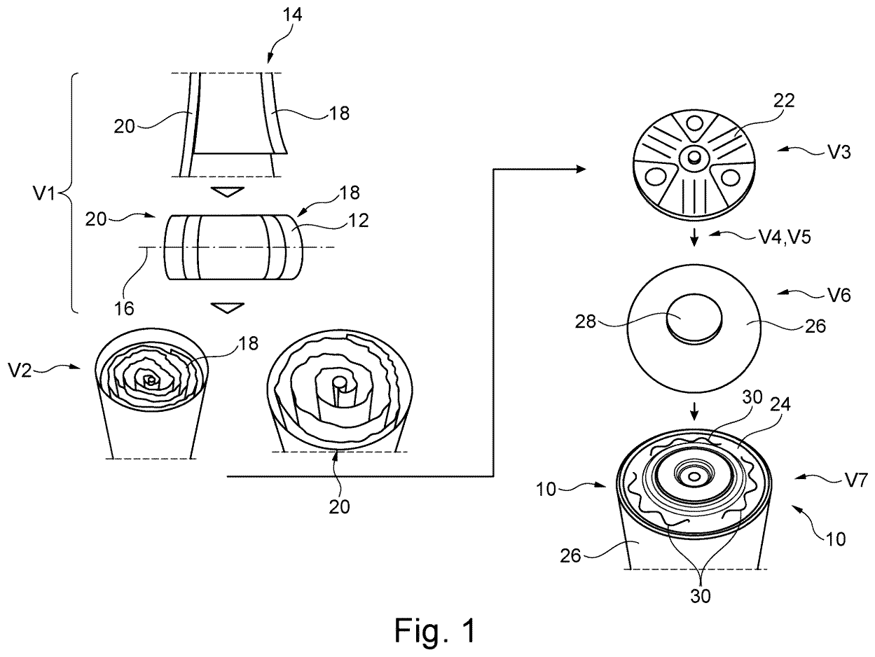

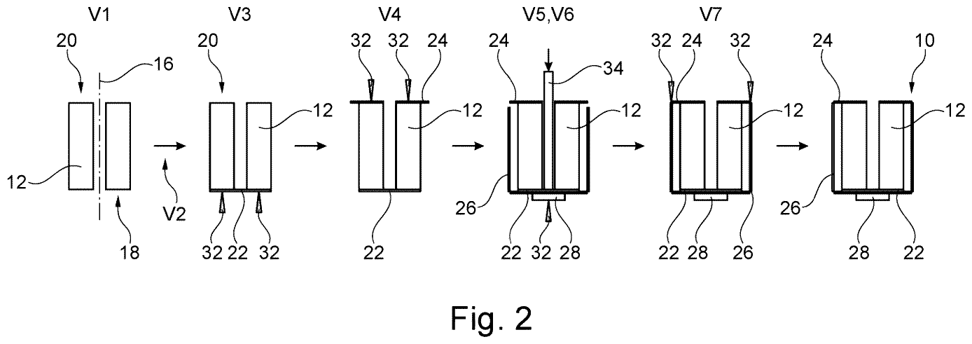

In FIGS. 1 and 2, respective process steps of a method for manufacturing a cylindrical battery cell 10 for a traction battery of a motor vehicle are illustrated. In particular, the traction battery of the motor vehicle comprises a multiplicity of cylindrical battery cells 10. The battery cells 10 are designed to supply electrical energy for an electric drive train of the motor vehicle, as a result of which the motor vehicle can be driven by means of electrical energy from the battery cells 10. The battery cells 10, in particular, can be part of a high-voltage energy store of the motor vehicle.

The battery cell 10 comprises an electrode coil 12, which is manufactured by winding a multi-layer foil 14 about a coil axis 16 in a first process step V1. The multi-layer foil 14 comprises at least one anode which is embodied in the form of a foil, and at least one cathode which is embodied in the form of a foil, which is electrically isolated from the anode which is embodied in the form of a foil by means of a separator. A foil-like cathode contact region 18 adjoins the cathode, whereas a foil-like anode contact region 20 adjoins the anode. The cathode contact region 18 and the anode contact region 20 extend along mutually opposing sides of the multi-layer foil 14, as can be seen in the illustrations of the first process step V1 in FIG. 1.

Further to the winding of the multi-layer foil 14 about the coil axis 16 to form the electrode coil 12, the anode contact region 20 and the cathode contact region 18 are respectively arranged on mutually opposing end faces of the electrode coil 12. As a result of the winding of the multi-layer foil 14, in the electrode coil 12, the respective contact regions protrude in an at least essentially perpendicular manner at the end faces of the electrode coil 12. In order to form respective contact surfaces at the end faces of the electrode coil 12 for contact-connecting the anode or cathode by means of the respectively assigned contact region, the respective contact regions at the end faces of the electrode coil 12 are flattened in a second process step V2. In the present case, the cathode contact region 18 and the anode contact region 20, as can be seen from the illustrations of the first process step V1 in FIG. 1, are respectively configured as a continuous region along the respective side of the multi-layer foil 14. Alternatively, the cathode contact region 18 or the anode contact region 20 can be respectively subdivided into a multiplicity of pennant-shaped segments which, upon flattening, are partially mutually overlaid.

Upon the flattening of the contact regions, which are configured as continuous regions, the respective contact regions, at the end faces of the electrode coil, are bent over radially from the exterior towards the interior, as a result of which different sections of the respective contact region which is arranged on the end face engage in mutual contact, such that a continuous contact surface is formed on the respective end face. The respective contact regions which are to be flattened are represented in conjunction with the second process step V2 in FIG. 1. In a third process step V3, a cathodic current collector plate 22 is welded to the flattened cathode contact region 18. In a fourth process step V4, which is not pictorially illustrated in FIG. 1, a housing cover 24 is welded directly to the flattened anode contact region 20. Thereafter, in a fifth process step V5, the electrode coil 12 is inserted in a housing cylinder 26 and, in a sixth process step V6, is electrically bonded to a positive pole 28 of the housing cylinder 26, in the present case by welding. In a seventh process step V7, the housing cover 24 which is directly welded to the anode contact region 20 is welded to the housing cylinder 26, in order to close a housing of the battery cell 10 which is formed of the housing cover 24 and the housing cylinder 26.

As can be seen in the representation of the housing of the battery cell 10 which is illustrated in conjunction with the seventh process step V7, in the present case, the housing cover 24 is welded to the anode contact region 20 by means of multiple curved and sinusoidally undulating welded seams 30. By means of the undulating configuration of the welded seams 30, the anode contact region 20 is materially bonded to the housing cover 24 over a particularly large surface area. As the respective welded seams 30 extend circumferentially about the coil axis 16 on the end face of the electrode coil 12 which is assigned to the anode contact region 20, in respective circular segments, the housing cover 24, over its entire perimeter, is retained on the anode contact region 20 in a particularly secure manner, and is electrically contact-connected with the anode contact region 20 in a particularly secure manner. As a result of the waveform of the welded seams 30, the latter are contact-connected about the coil axis 16 with a particularly high number of different sections of the anode contact region 20 from different winding layers of the multi-layer foil 14. Respective electrodes can thus flow over a particularly short path between the housing cover 24 and the anode, via the anode contact region 20. A particularly rapid charging and discharging of the battery cell 10 is enabled as a result.

In the process diagram represented in FIG. 2, the first process step V1, and the third process step V3 through to the seventh process step V7 are schematically represented in respective sectional views. In FIG. 2, the electrode coil 12 which is manufactured in the context of the first process step V1 is represented, at the respective end faces of which the contact regions 18, 20 are arranged. Moreover, the third process step V3 is represented in which, by means of a laser device, the cathodic current collector plate 22 is welded to the cathode contact region 18, wherein welding is indicated by the respective arrows 32. FIG. 2 moreover illustrates how, in the fourth process step V4, the housing cover 24 is welded directly to the flattened anode contact region 20. Thereafter, in the fifth process step V5, the electrode coil 12, with the cathodic current collector plate 22 which is welded to the cathode contact region 18, is inserted to the front of the housing cylinder 26. Thereafter, in the sixth process step V6, the cathodic current collector plate 22 is electrically bonded to the positive pole 28 of the housing cylinder 26. To this end, the cathodic current collector plate 22 can be welded to the positive pole 28, as indicated by the arrow 32 associated with the sixth process step V6. In the region of the coil axis 16, as can be seen from FIG. 2, a core 34 can be centrally and axially inserted in the electrode coil 12, which insertion, in the interests of optimum representation associated with the finished battery cell 10, is not represented. The core 34 extends, in its longitudinal direction of extension, in an axial direction of insertion into the electrode coil 12. In a seventh process step V7, the housing cover 24 is welded to the housing cylinder 26, as a result of which the manufacture of the battery cell 10 is complete. Thereafter, a final inspection of the battery cell 10 can be executed.

For the manufacture of the battery cell 10, the electrode coil 12 can firstly be inserted into the housing cylinder 26, whereafter the core 34 is centrally and axially inserted into the electrode coil 12 and, thereafter, the cathodic current collector plate 22 is welded to the positive pole 28. The battery cell 10 described, by means of the method described, can be manufactured in a particularly rapid manner, as a welding of an anodic current collector plate to the anode contact region 20 is omitted. Moreover, in the battery cell 10 described, a particularly high volumetric utilization of structural space is achieved.

The method described enables the battery cell 10 to be manufactured in a particularly small-scale production line, with a particularly small number of components, and thus in a particularly cost-effective manner. Moreover, the battery cell 10 enables a particularly high volumetric utilization of available structural space, and a particularly low weight of the battery cell 10. On the grounds of the particularly low number of sequential production steps, the battery cell 10 can be manufactured in a particularly rapid manner, or a particularly high number of battery cells 10 can be manufactured in a given time period.

Overall, the invention discloses how a battery cell 10 having a directly laser-welded housing cover 24 can be provided.

### LIST OF REFERENCE SYMBOLS

10 Battery cell
12 Electrode coil
14 Multi-layer foil
16 Coil axis
18 Cathode contact region
20 Anode contact region
22 Cathodic current collector plate
24 Housing cover
26 Housing cylinder
28 Positive pole
30 Welded seam
32 Arrow
34 Core
V1-V7 Respective process steps

1.-10. (canceled)

11. A method for manufacturing a cylindrical battery cell for a traction battery of a motor vehicle, comprising:
winding a multi-layer foil, which at least comprises a cathode which is embodied in the form of a foil, having a foil-like cathode contact region which is electrically contiguous thereto, and at least one anode which is embodied in the form of a foil, having a foil-like anode contact region which is electrically contiguous thereto, to form an electrode coil, at a first end face of which the cathode contact region is arranged, and at a second end face of which the anode contact region is arranged;
flattening the cathode contact region and the anode contact region at the respective end faces;
welding a cathodic current collector plate to the flattened cathode contact region;
welding a housing cover directly to the flattened anode contact region;
inserting the electrode coil in a housing cylinder;
electrically bonding the cathodic current collector plate to a positive pole of the housing cylinder; and
bonding the housing cover to the housing cylinder.

12. The method according to claim 11, wherein
the cathode contact region extends as a continuous region along a first side of the multi-layer foil, and
the anode contact region extends as a continuous region along a second side of the multi-layer foil, which is arranged opposite the first side and, upon flattening, the respective continuous regions are reshaped towards a central axis of the electrode coil.

13. The method according to claim 11, wherein
the cathode contact region and the anode contact region are respectively subdivided into a multiplicity of pennant-shaped segments which, upon flattening, are partially mutually overlaid.

14. The method according to claim 11, wherein
the housing cover is welded to the housing cylinder.

15. The method according to claim 11, wherein
the cathodic current collector plate is welded to the positive pole.

16. The method according to claim 11, further comprising:
axially inserting a core in a center of the electrode coil.

17. The method according to claim 11, wherein
the housing cover is welded to the flattened anode contact region via at least one curved and undulating welded seam.

18. The method according to claim 17, wherein the welded seam is sinusoidally undulating.

19. The method according to claim 17, wherein
multiple curved and undulating welded seams are distributed over a perimeter of the housing cover in a mutually uniformly spaced arrangement.

20. A cylindrical battery cell for a traction battery of a motor vehicle, comprising:
an electrode coil which is wound from a multi-layer foil, which comprises at least one cathode which is embodied in the form of a foil, having a foil-like cathode contact region which is electrically contiguous thereto, and an anode which is respectively embodied in the form of a foil, having a foil-like anode contact region which is electrically contiguous thereto,
wherein the cathode contact region is arranged and flattened at a first end face of the electrode coil, and
wherein the anode contact region is arranged and flattened at the second end face of the electrode coil, which is arranged opposite the first side;
a cathodic current collector plate, which is welded to the flattened cathode contact region;
a housing cover, which is welded directly to the flattened anode contact region; and
a housing cylinder, in which the electrode coil is inserted, to the positive pole of which the cathodic current collector plate is electrically bonded, by welding, and to which the housing cover is welded.
